(19) United States
(12) Patent Application Publication
(10) Pub. No.: US 2005/0056092 A1
(43) Pub. Date: Mar. 17, 2005

(54) Liquid level indicator using lights

(76) Inventor: Kenneth H. Kowalski, Strongsville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/661,693

(22) Filed: Sep. 12, 2003

(51) Int. Cl. G01F 23/74

(52) U.S. Cl. 73/313; 73/DIG. 5; 73/293

(57) ABSTRACT

An indicator assembly for indicating the level of liquid in a tank includes one or more columns of lights that are turned on or off as the level of liquid in the tank rises and falls. The lights may be turned on and off by the passage of a magnetic float that changes the state of magnetically actuatable switches, such as Hall effect transistors, that are associated in a one-to-one relationship with the lights. If two columns of lights are used, they may be of different colors.

### BACKGROUND OF THE INVENTION

It is known to indicate the level of liquid in a tank or reservoir with mechanical flags. A magnet or magnet assembly is movable up and down with the level of liquid in the tank. As the level of liquid in the tank drops, the magnet moves down alongside the column of flags, which extends for the entire height of the tank. As the magnet passes the flags, it causes the flags to turn, one by one, from a light color to a dark color (or vice versa). Thus, the overall appearance of the column gradually changes, providing an indication of the vertical location of the magnet. The appearance of the column provides an indication of the level of the liquid in the tank. One drawback to this type of level indicator is that it is not inherently visible in darkness. In addition, it includes numerous moving parts (the mechanical flags) that, over time, might stick or lock up.

It is also known to indicate the level of liquid in a tank or reservoir by moving a magnet along a column of individually actuatable, non-latching reed switches. The reed switches are associated in a one-to-one relationship with a column of resistors in series. The resistors are electrically connected with remote electrical circuitry. As the level of liquid in the tank drops, the magnet moves down alongside the column of reed switches. As the magnet passes the reed switches, it causes the reed switches to close, one by one, gradually increasing the overall resistance of the column of resistors. The resistance is sensed by the remote electric circuitry to provide an indication, on a display, of the vertical location of the magnet. The sensed resistance provides an indication to a computer of the level of the liquid in the tank.

### SUMMARY OF THE INVENTION

The present invention relates to a liquid level indicator assembly and to a method of indicating the level of liquid in a tank. The indicator assembly includes one or more columns of lights that are turned on or off as the level of liquid in the tank rises and falls. The lights may be turned on and off by the passage of a magnetic float that changes the state of magnetically actuatable switches, such as Hall effect transistors, that are associated in a one-to-one relationship with the lights. If two columns of lights are used, they may be of different colors, so that the overall appearance of the assembly changes color, for example, from red to green.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of a liquid level indicator assembly associated with a tank containing liquid;

FIG. 2 is an enlarged schematic view of a portion of the indicator assembly of FIG. 1 associated with the tank and a gauge assembly;

FIG. 3 is a schematic front elevational view of a portion of the indicator assembly showing several rows of lights that form part of the indicator assembly;

FIG. 4 is a schematic rear elevational view of a portion of the indicator assembly showing several rows of switches that form part of the indicator assembly;

FIG. 5 is an electrical schematic diagram of a portion of the indicator assembly;

FIG. 6 is a view similar to FIG. 3 of a portion of an indicator assembly constructed in accordance with a second embodiment of the invention;

FIG. 7 is a schematic rear elevational view of a portion of the indicator assembly of FIG. 6; and

FIG. 8 is an electrical schematic diagram of a portion of the indicator assembly of FIG. 6.

### DESCRIPTION OF THE INVENTION

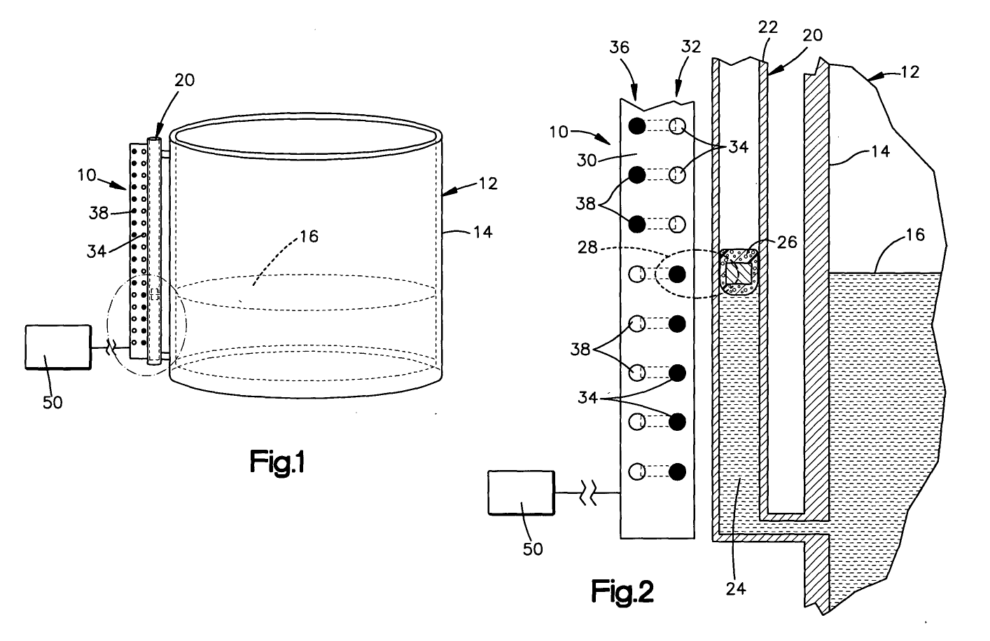

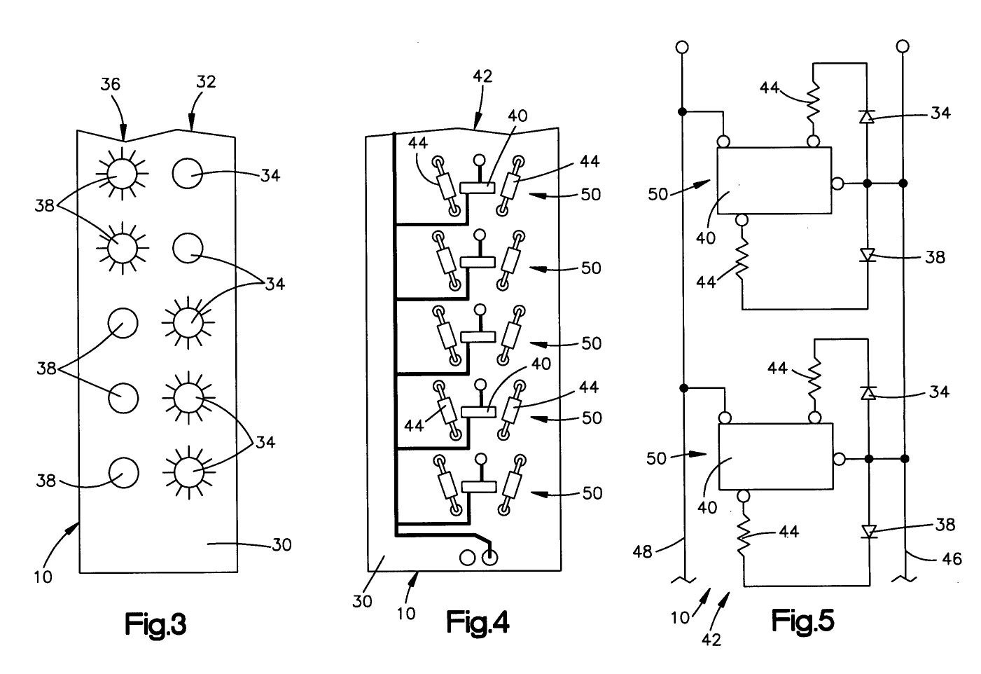

The present invention relates to an indicator assembly for indicating the level of liquid in a tank. The invention is applicable to indicator assemblies of varying constructions. As representative of the invention, FIGS. 1-5 illustrate an indicator assembly 10 that is constructed in accordance with a first embodiment of the invention.

The indicator assembly as illustrated is used for indicating the level of liquid in a tank, such as the tank shown schematically at 12. The tank 12 has a side wall 14. The liquid level in the tank shown in FIG. 1 is indicated by the line 16. The indicator assembly 10 is usable with other types of tanks or reservoirs or liquid containers than that shown.

A gauge assembly 20 is mounted on the tank side wall 12. The gauge assembly 20 may be of one of the types shown in U.S. Pat. Nos. 5,647,656; 5,645,336; and 5,743,137, the disclosures of which are incorporated herein by reference. The gauge assembly 20 as illustrated includes a cylinder 22 containing liquid 24. The level of the liquid 24 in the cylinder 22 varies with the liquid level 16 in the tank 12.

A float 26 is suspended in the liquid 24 in the cylinder 22 and rises and falls with the liquid level in the cylinder 22. The level of the float 26 thus indicates the liquid level 16 in the tank 12. The float 26 carries a magnet or magnet assembly that produces a magnetic field, indicated schematically at 28.

The indicator assembly 10 is supported adjacent the gauge assembly 20. The indicator assembly 10 includes a substrate or base 30. In one embodiment, the indicator assembly 10 is formed as a printed circuit assembly with components mounted on a suitable circuit board as the base 30.

Two columns of lights are mounted on the base 30. The two columns include a first column 32 including a plurality of lights 34, and a second column 36 including a plurality of lights 38. The lights 34 and 38 are preferably LED's, but could be another type of light. When the indicator assembly 30 is in use it is mounted so that the columns 32 and 36 extend vertically alongside the gauge assembly 20.

The lights in the two columns 32 and 36 are of different colors when energized. In the illustrated embodiment, the lights 34 in the first column 32 are red LED's, and the lights 38 in the second column 36 are green LEDs.

Also mounted on the base 30 of the indicator assembly are a plurality of magnetically actuated switches 40 that are electrically connected with the lights 34 and 38 in a circuit 42 as described below. A plurality of resistors 44 are also mounted on the base 30 and are electrically connected with the switches 40 and the lights 34 and 38 in the circuit 42 as described below.

The switches 40 are preferably Hall effect transistors. Hall effect transistors are preferred because they are activated by such a magnetic field, they are less expensive than reed switches, and are more durable thermally, electrically, and physically. The Hall effect transistors could, alternatively, be replaced another type of switch 40, such as a reed switch, which can be switched by the particular level of magnetic force that is generated by the gauge assembly 26. One commercial gauge assembly 20 generates approximately 120 gauss in the plane of the switches 40.

As shown schematically in FIGS. 4 and 5, the circuit 42 on the board 30 includes a plurality or series of “cells” 50 each of which includes two lights 34 and 38, a transistor 40, and two resistors 44. The two lights 34 and 38 are connected with one terminal of the transistor 40. The one terminal is also connected to a positive bus 46 on the base 30.

The red light 34 is connected in series with one resistor 44 to a second terminal of the transistor 40. The green light 38 is connected in series with the other resistor 44 to a third terminal of the transistor 40. A fourth terminal of the transistor 40 is connected to a negative bus 48 on the base 30.

A remote readout, indicated schematically at 50, is electrically connected with the indicator assembly 10. The remote readout 50 can be a series of lights, or a gauge, or a computer system, for example, located in a building or room that is adjacent to or remote from the actual tank 12.

As the liquid level 16 in the tank 12 rises and falls, the level of the liquid 24 in the cylinder 22 also rises and falls. The float 26 moves with the liquid level in the cylinder 22, that is, in response to rising or falling liquid level 16 in the tank 12. As the float 26 moves, the magnetic field 28 that it produces moves vertically along the length of the indicator assembly 10.

When the indicator assembly 10 is first powered up, all the Hall effect transistors 40 are in steady state closed output. As a result, all the red lights 32 are energized (assuming no magnetic field is present at the location of the transistors 40).

As the float 26 rises or falls, it actuates serially the switches 40. Specifically, as the float 26 rises past each transistor 40, the magnetic field 28 of the moving float causes, in response, a small current to be generated within each transistor that the field passes. This current switches the output of the transistor 40 so that the open output closes and the closed output opens. In response, the red light 32 is de-energized and the green light 36 is energized.

Thus, as the float 26 and its magnetic field 28 move upward along the length of the indicator assembly 10, past the levels indicated by the pairs of associated red and green lights 32 and 36, the red light 32 at each level is replaced with a green light 36. As a result, in the indicator assembly 10 one and only one member of each pair of lights 32 and 36 is illuminated.

The transistors 40 are latching devices. Therefore, when the magnetic field 28 moves away from a transistor 40, the transistor maintains its state until another, subsequent, magnetic force causes it to switch back to its previous state. Thus, when a red light 32 is turned on or off, it maintains that state, and when a green light 36 is turned on or off, it also maintains that state.

As a result, the level of liquid 16 in the tank 12 is visible external to the tank 12, in a self-illuminated manner that can be seen in the dark. In addition, the remote readout 50 can indicate remotely the level of liquid 16 in the tank 12. Thus, the level of liquid 16 in the tank 12 can be read both at the tank itself, near (within visible range) of the tank, and at any distance over which an electrical signal can be sent.

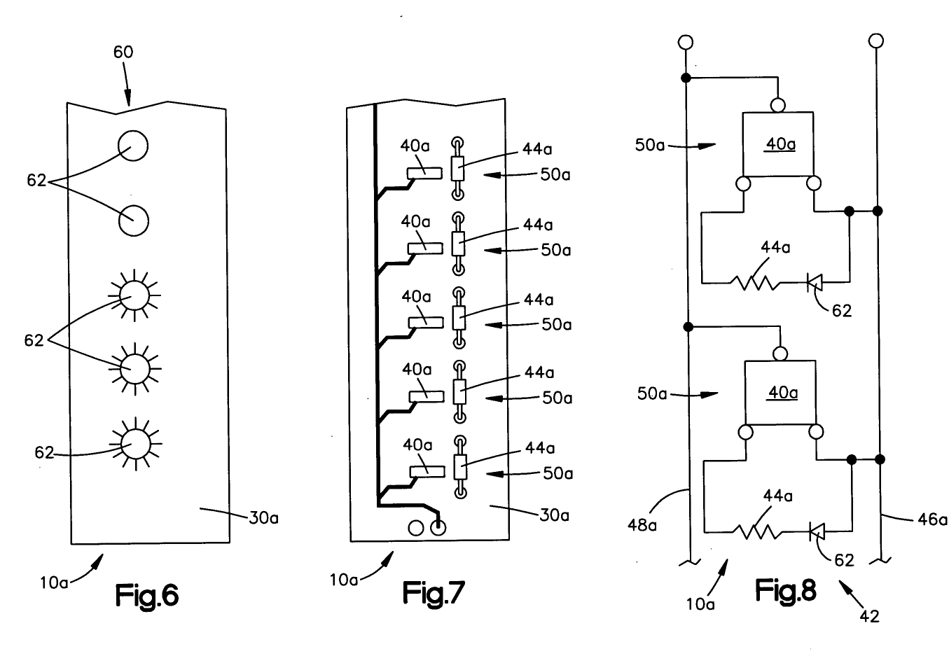

FIGS. 6-8 illustrate an indicator assembly 10a that is constructed in accordance with a second embodiment of the invention. Parts of the indicator assembly 10a that are the same as or similar to parts of the indicator assembly 10 (FIGS. 1-5) are given the same reference numerals with the suffix “a” attached.

The indicator assembly 10a includes only one column 60 of lights 62 mounted on the base 30a. The lights 62 are preferably LED's arranged in rows, with only one LED in each row. All the lights 62 are preferably of the same color, and could be, for example, white when illuminated. When the indicator assembly 10a is in use it is mounted so that the column 60 of lights 62 extends vertically alongside a gauge assembly.

Also mounted on the base 30a of the indicator assembly 10a are a plurality or series of magnetically actuated switches 40a that are electrically interconnected with the lights 62 as described below. As in the first embodiment, the switches 40a are preferably Hall effect transistors. A plurality or series of resistors 44a are also mounted on the base 30 in a one-to-one relationship with the switches 40a and the lights 62.

As shown schematically in FIGS. 7 and 8, the circuit 42a on the board 30a includes a plurality or series of “cells” 50a each of which includes one light 62, a transistor 40a, and one resistor 44a. The light 62 is connected with one terminal of the transistor 40a that is connected to a positive bus 46a on the base 30a. The light 62 is connected in series with the resistor 44a to a second terminal of the transistor 40a. A third terminal of the transistor is connected to a negative bus 48a on the base 30a. A remote readout (not shown) may also be electrically connected with the indicator assembly 10a.

The indicator assembly 10a is associated in operation with a tank 12 and a gauge assembly 20 as in the first embodiment of the invention. When the indicator assembly 10a is first powered up, all the Hall effect transistors 40a are in steady state closed output. As a result, all the lights 62 are energized (assuming no magnetic field is present at the location of the transistors 40a).

As the float 26 rises or falls, it actuates serially the switches 40a. Specifically, as the float 26 falls past each transistor 40a, the magnetic field 28 of the moving float causes, in response, a small current to be generated within each transistor that the field passes. This current switches the outputs of the transistor 40a, and in response, the light 62 associated with the transistor is de-energized (turned off).

Thus, as the float 26 and its magnetic field 28 move downward along the length of the indicator assembly 10a, past the levels indicated by the lights 62, the energized light at each level is replaced with a de-energized light. When the magnetic field 28 moves away from a transistor 40a, the associated light 62 maintains its on or off state until a subsequent magnetic field switches the transistor. As a result, the indicator assembly 10a provides an indication of the level of liquid in the tank 12 which is visible external to the tank, in a self-illuminated manner, that can be seen in the dark. In addition, the level of liquid in the tank 12 can be read remotely, as above, if desired.

From the above description of the invention, those skilled in the art will perceive improvements, changes, and modifications in the invention. For example, each row of lights could include more than two lights, and a remote readout need not be used. Such improvements, changes, and modifications within the skill of the art are intended to be included within the scope of the appended claims.

1. An indicator assembly for indicating the level of liquid in a tank, said indicator assembly comprising:
a float external to the tank that rises and falls with the level of liquid in the tank and that produces a magnetic field that moves vertically as the float rises and falls;
a plurality of magnetically actuatable switches that are actuated as the magnetic field passes said switches; and
a plurality of lights that are electrically connected with said switches and that are turned on or off as said magnetic field passes said switches.

2. An indicator assembly as set forth in claim 1 wherein said lights are LEDs and said switches are Hall effect transistors.

3. An indicator assembly as set forth in claim 1 further comprising a remote readout that is electrically connected with said plurality of switches for indicating remotely from said tank the level of liquid in said tank.

4. An indicator assembly as set forth in claim 1 wherein said plurality of lights comprises a single column of lights associated in a one to one relationship with said plurality of switches, each one of said lights being either on or off depending the state of its associated switch.

5. An indicator assembly as set forth in claim 1 wherein said plurality of lights comprises a first column of first lights and a second column of second lights, forming pairs of two lights including a first light and an associated second light, each pair of two lights being associated in a one to one relationship with one of said plurality of switches, in each pair of two lights one of said first and second lights being on and the other one of said first and second lights being off depending on the state of said switch associated with said row of two lights.

6. An indicator assembly as set forth in claim 5 wherein said first lights are a first color and said second lights are a second color different from said first color.

7. An indicator assembly as set forth in claim 6 wherein said first lights are red and said second lights are green.

8. An indicator assembly as set forth in claim 1 wherein said plurality of lights includes a plurality of first lights of a first color and a plurality of second lights of a second color.

9. An indicator assembly as set forth in claim 8 wherein said first lights are red and said second lights are green.

10. An indicator assembly as set forth in claim 1 wherein said switches and said lights are on the same circuit board.

11. An indicator assembly for indicating the level of liquid in a tank in response to movement of a float that rises and falls with the level of liquid in the tank and that produces a magnetic field that moves vertically as the float rises and falls, said indicator assembly comprising:
a plurality of magnetically actuatable switches that are actuatable as the magnetic field passes said switches;
an electrically actuated visible indicator electrically connected with said switches and that is selectively actuatable as the magnetic field passes said switches; and
a remote readout that is electrically connected with said switches for indicating remotely from the tank the level of liquid in the tank.

12. An assembly as set forth in claim 11 wherein said electrically actuated visible indicator comprises a plurality of lights that are selectively turned on and off as the magnetic field passes said switches.

13. An assembly as set forth in claim 12 wherein said lights are arranged in a single column and each one of said lights in said single column is either on or off.

14. An assembly as set forth in claim 12 wherein said lights are arranged in pairs, and in each pair, one and only one of said lights is on.

15. An assembly as set forth in claim 14 wherein the two lights in each one of said pairs are of a different colors.

16. Liquid level indicator apparatus comprising:
a circuit board;
a plurality of LED's on said circuit board arranged in a series of rows, each row having at least two LED's; and
a plurality of magnetically actuatable switches on said circuit board and associated in a one to one relationship with said rows of LED's;
said circuit board adapted to be mounted adjacent a container of liquid, said switches being actuatable serially as the liquid level in the container rises and falls thereby to turn said LED's on or off.

17. Apparatus as set forth in claim 16 wherein each one of said rows of LED's on said circuit board includes two LED's of different colors associated electrically with said switches so that one and only one of said LED's in each row is turned on at a time.

18. Apparatus as set forth in claim 17 wherein said switches are Hall effect transistors.

19. A method of indicating level of liquid in a tank, comprising the steps of:
moving a magnetic field external to the tank past a series of magnetically actuatable switches connected with a series of lights, in response to rise and fall of the liquid level in the tank;
actuating one of the switches with the moving magnetic field; and
turning a light on or off in response to actuation of the switch.

20. A method as set forth in claim 19 wherein the series of lights includes rows of lights each row including at least two lights of different colors, and wherein said step of turning a light on or off in response to actuation of the switch comprises turning one light of the at least two lights on and the other light of the at least two lights off.

21. A method as set forth in claim 19 wherein said the series of lights includes rows of lights each including a single light, and wherein said step of turning a light on or off in response to actuation of the switch comprises turning the one either on or off.

22. Apparatus for indicating the level of liquid in a tank in response to movement of a magnetic field that rises and falls over a span as the level of liquid in the tank varies, said apparatus comprising:
first indicator means having a first visible state for indicating visibly the amount of the span that is above the magnetic field;
second indicator means having a second visible state different from the first visible state for indicating visibly the amount of the span that is below the magnetic field; and
means for changing the visible state of said first indicator means and of said second indicator means in response to movement of the magnetic field.

23. Apparatus as set forth in claim 22 wherein said first indicator means comprises a first plurality of visible indicators in a first array and said second indicator means comprises a second plurality of visible indicators in a second array.

24. Apparatus as set forth in claim 23 wherein the first plurality of visible indicators have a visible state that is different from the visible state of the second plurality of visible indicators.

25. Apparatus as set forth in claim 24 wherein said first and second pluralities of visible indicators are arrays of lights of different colors.

26. Apparatus for indicating the level of liquid in a tank in response to movement of a magnetic field that rises and falls over a span as the level of liquid in the tank varies, said apparatus comprising:
a first indicator responsive to a change in the magnetic field caused by movement of the magnetic field over the span adjacent said first indicator, said first indicator having a first visible state for indicating visibly the amount of the span that is above the magnetic field; and
a second indicator responsive to a change in the magnetic field caused by movement of the magnetic field vertically over the span adjacent said second indicator, said second indicator having a second visible state different from the first visible state for indicating visibly the amount of the span that is below the magnetic field.

27. Apparatus as set forth in claim 26 wherein the first indicator has a variable length proportional to the amount of the span that is above the magnetic field and the second indicator has a variable length proportional to the amount of the span that is below the magnetic field.

28. Apparatus as set forth in claim 26 wherein the first visible state of the first indicator is a first illuminated state and wherein the first visible state of the second indicator is a second illuminated state different from the first illuminated state.

29. Apparatus as set forth in claim 28 wherein the first illuminated state is illumination with a first color and the second illuminated sate is illumination with a second color.

30. Apparatus for indicating the level of liquid in a tank in response to movement of a magnetic field that rises and falls over a span as the level of liquid in the tank varies, said apparatus comprising:
at least two adjacent sets of electrically actuatable latching visible indicators forming pairs of at least two visible indicators, the visible indicators in the first set being actuatable by the magnetic field to a first visible state and the visible indicators in the second set being actuatable by the magnetic field to a second visible state different from the first visible state;
all of the electrically actuatable visible indicators being latchable so that a visible indicator maintains its visible state when the magnetic field moves away until another, subsequent, magnetic field causes the visible indicator to switch to another visible state.

31. Apparatus as set forth in claim 30 wherein the electrically actuatable visible indicators are lights that are electrically actuatable to be illuminated.

32. Apparatus as set forth in claim 31 wherein the visible states are states of color.

33. Apparatus as set forth in claim 31 wherein the lights are electrically connected with switches that are turned on or off as said magnetic field passes said switches, each pair of lights being associated in a one to one relationship with one switch, in each pair of lights one light being on and the other light being off depending on the state of said switch associated with said pair.
